(19) United States
(12) Patent Application Publication
(10) Pub. No.: US 2008/0109618 A1
(43) Pub. Date: May 8, 2008

(54) Parallel interleaving apparatus and method

(75) Inventors: Dong-Ho Kim, Seoul (KR); Yung-Soo Kim, Seongnam-si (KR); Cheol-Woo You, Seoul (KR); Hong-Yeop Song, Seoul (KR); Dae-Son Kim, Seoul (KR); Hyun-Young Oh, Anyang-si (KR)

Correspondence Address: DOCKET CLERK, P.O. DRAWER 800889, DALLAS, TX, 75380, US

(73) Assignees: SAMSUNG ELECTRONICS CO. , LTD., Suwon-Si (KR); Industry-Academic Cooperation Foundation, Yonsei University, Seoul (KR)

(21) Appl. No.: 11/983,106

(22) Filed: Nov. 7, 2007

(30) Foreign Application Priority Data
Nov. 7, 2006 (KR) 2006-109627

(51) Int. Cl. G06F 12/06

(52) U.S. Cl. 711/157; 711/E12.079

(57) ABSTRACT

Provided is a parallel interleaving method and apparatus. The parallel interleaving method includes dividing input information bits into a predetermined number of sub-blocks and interleaving the information bits divided into the sub-blocks according to a predetermined first interleaving rule.

### CROSS-REFERENCE TO RELATED APPLICATION AND CLAIM OF PRIORITY

The present application claims the benefit under 35 U.S.C. § 119(a) of a Korean Patent Application filed in the Korean Intellectual Property Office on Nov. 7, 2006 and assigned Serial No. 2006-109627, the entire disclosure of which is hereby incorporated by reference.

### TECHNICAL FIELD OF THE INVENTION

The present invention relates to interleaving, and in particular, to an interleaving apparatus and method capable of parallel processing.

### BACKGROUND OF THE INVENTION

Next-generation communication systems have evolved into packet service communication systems. The packet service communication systems transmit burst packet data to a plurality of mobile stations and have been designed to be suitable for high-capacity data transmission. In particular, the next-generation communication systems use high-order modulation (HOM) in order to increase the amount of data transmission while using limited frequency resources. However, using HOM requires a higher signal-to-noise ratio (SNR) to acquire the same performance as using low-order modulation (LOM). In order to reduce the required SNR, highly efficient forward error correction (FEC) codes have to be used.

Representative ones among the FEC codes are a turbo code and a low density parity check (LDPC) code. The turbo code, which is one of channel coding techniques, has been actively studied since its introduction by Berrou in 1993. In particular, a turbo code that has a parallel structure draws much attention to solving a delay problem in decoding.

A turbo code having a parallel structure divides information blocks into a plurality of sub-blocks in order to perform encoding and decoding in parallel. Thus, there is a need for a new interleaver capable of parallel processing in place of a conventional interleaver used in the turbo code.

Berrou suggested an interleaver having a parallel structure with four (4) sub-blocks in his paper “Enhancement of Rel. 6 Turbo Code”, 3GPP TSG RAN WG1#43, Seoul, Korea, Nov. 7-11, 2005. In this paper, information block lengths are assumed to be 320 and 640, a max log map algorithm was used as a decoding algorithm, and the number of decoding repetitions was set to 8. While an interleaver having the parallel structure suggested by Berrou has superior performance over those of previously suggested interleavers, a problem arises in complexity due to optimization.

The following Equation 1 shows an interleaving rule having a period of 4.

$$p = \{ \begin{matrix}0 & if j = 0 [ mod 4 ] \\ {Q}_{1} & if j = 1 [ mod 4 ] \\ 4 * P + {Q}_{2} & if j = 2 [ mod 4 ] \\ 4 * P + {Q}_{3} & if j = 3 [ mod 4 ]\end{matrix} \qquad [ Eqn . 1 ]$$

In Equation 1, P, Q1, Q2, and Q3 are experimentally determined as values that exhibit best performance. In other words, when the information block lengths are 320 and 640, P, Q1, Q2, and Q3 have to be determined in order to design an interleaver having 4 sub-blocks. To this end, there are restrictions: P must be a co-prime to the information block lengths and Q1, Q2, and Q3 must be multiples of 4. Even considering these restrictions, a large amount of calculation is required to determine P, Q1, Q2, and Q3 values that exhibit best performance for all information block lengths.

In that paper, Berrou suggested P, Q1, Q2, and Q3 only for the information block lengths of 320 and 640 as follows.

P=197, Q₁=8, Q₂=20, Q₃=12

P=201, Q₁=24, Q₂=12, Q₃=4 [Eqn. 2]

However, in actual system implementation, P, Q1, Q2, and Q3 have to be determined for all information block lengths. As a result, it is not efficient to check up the number of cases for each of all the information block lengths in order to determine P, Q1, Q2, and Q3.

### SUMMARY OF THE INVENTION

To address the above-discussed deficiencies of the prior art, it is a primary aspect of the present invention to address at least the above problems and/or disadvantages and to provide at least the advantages described below. Accordingly, an aspect of the present invention is to provide an interleaving apparatus and method capable of parallel processing for all information block lengths.

Another aspect of the present invention is to provide a parallel interleaving apparatus and method capable of increasing decoding yields by making parallel decoding possible during a decoding process.

According to one aspect of the present invention, there is provided a parallel interleaving method including dividing input information bits into a predetermined number of sub-blocks and interleaving the information bits divided into the sub-blocks according to a predetermined first interleaving rule.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate interleaving and an S matrix according to an exemplary embodiment of the present invention; and

FIG. 2 is a flowchart illustrating a process of generating a matrix S according to an exemplary embodiment of the present invention.

### DETAILED DESCRIPTION OF THE INVENTION

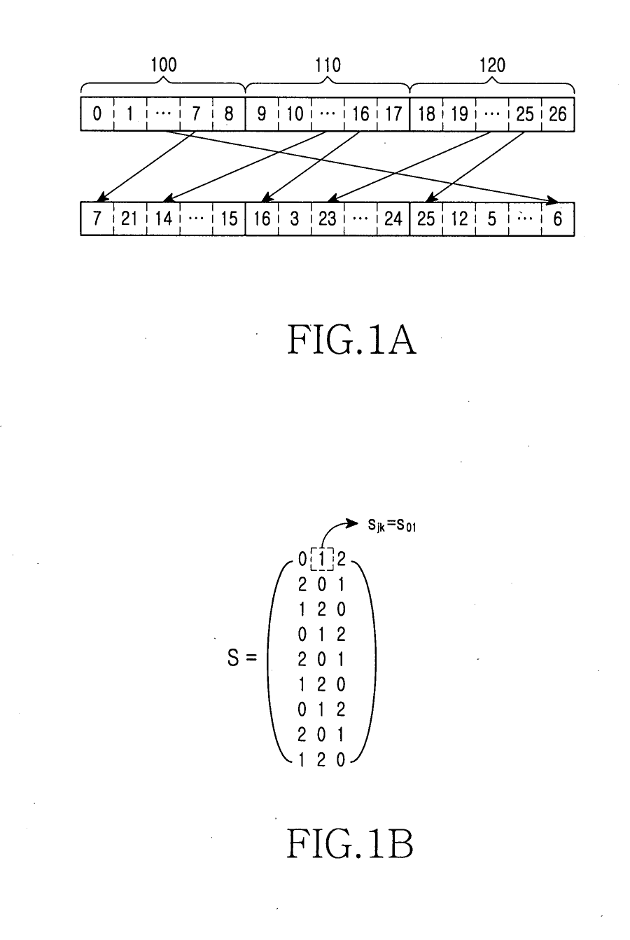

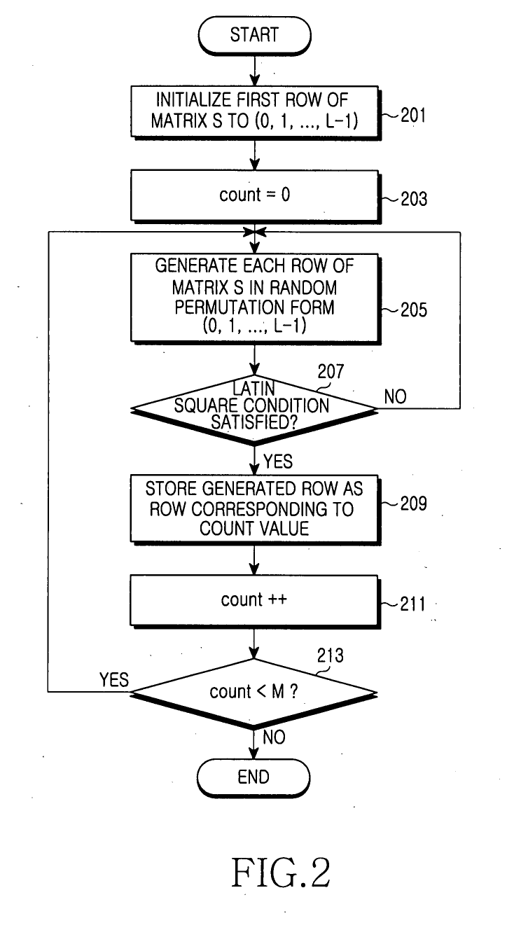

FIGS. 1 through 2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged interleaver apparatus.

The present invention suggests an interleaving method capable of parallel processing for all information block lengths. In particular, the present invention suggests a parallel interleaving apparatus and method capable of interleaving a long-length information block by using a short-length interleaver.

It is assumed that the length of all information blocks is K, the number of sub-blocks is L, and the number of information blocks for each sub-block is M. Then, M=K/L and M is not a multiple of (2m−1), where m is the number of shift registers of a convolutional encoder. If M is a multiple of (2m−1), circular encoding cannot be used. Circular encoding performs tail-biting without adding a tail bit to each sub-block.

In the present invention, a long-length interleaver capable of parallel processing can be designed using a short-length interleaver (i.e., an interleaver having a length of M). A matrix S indicating interleaving between sub-blocks is expressed as M×L. Each row of the matrix S must be a permutation from 0 to L−1.

For example, for parallel-structure interleaving with 4 sub-blocks (i.e., L=4), four (4) processors which independently perform decoding in a decoder simultaneously read four (4) bits. This process is terminated when each of the processors an Mth information block (i.e., an Mth bit).

As such, an interleaving rule suggested by the present invention can be expressed as follows:

i=Π(k*M+j)=M×sⱼₖ+π(j). [Eqn. 3]

In Equation 3, k indicates an index of a sub-block from 0 to L−1, n indicates an interleaving rule of an interleaver having a length of M, Π indicates an interleaving rule of an interleaver according to the present invention, and sⱼₖ indicates an element in a j^{th} row and a k^{th} column of the matrix S for sub-block selection, where j=0, 1, . . . , M−1 and k=0, 1, . . . , L−1.

Hereinafter, interleaving capable of parallel processing by dividing sub-blocks and using a generated matrix S will be described with reference to FIGS. 1A and 1B.

FIGS. 1A and 1B illustrate interleaving and a matrix S according to an exemplary embodiment of the present invention.

Referring to FIGS. 1A and 1B, it is assumed that the length of all information blocks K is 27, the number of sub-blocks L is 3 (k=0, 1, 2), the number of information blocks for each sub-block M is 9 (j=0, 1, . . . , 8), and an interleaving rule of a short-length interleaver n=(7, 3, 5, 0, 4, 1, 8, 2, 6). The interleaving rule of the short-length interleaver may also be configured variously without being limited to the above-described example. The matrix S is a 9×3 matrix in which a 3×3 Latin square is repeated. Numbers shown in FIG. 1A indicate indices of information blocks. The index has a value from 0 to 26.

Since the entire information blocks are divided into 3 sub-blocks, 3 interleaving processors are required and interleaving is performed at points of time from 0 to 8.

First, at a 0^{th} point of time, a first processor reads an 8^{th} information block of a 0^{th} sub-block 100 (i.e., a bit corresponding to the index 7) using Equation 3 and the interleaving rule of the short-length interleaver. In other words:

i=M×sⱼₖ+π(j)=9×0+7=7.

At the same time, a second processor reads an 8^{th} information block of a 1^{st} sub-block 110 (i.e., a bit corresponding to the index 16) using Equation 3 and the interleaving rule of the short-length interleaver. In other words:

i=M×sⱼₖ+π(j)=9×1+7=16.

At the same time, a third processor also reads an 8^{th} information block of a 2^{nd} sub-block 120 (i.e., a bit corresponding to the index 25) using Equation 3 and the interleaving rule of the short-length interleaver. In other words:

i=M×sⱼₖ+π(j)=9×2+7=25.

Those read index values are interleaved in the first position of each sub-block.

Next, at a 1^{st} point of time, the first processor reads a 4^{th} information block of the 2^{nd} sub-block 120 (i.e., a bit corresponding to the index 21) using Equation 3 and the interleaving rule of the short-length interleaver. In other words:

i=M×sⱼₖ+π(j)=9×2+3=21.

At the same time, the second processor reads a 4^{th} information block of the 0^{th} sub-block 100 (i.e., a bit corresponding to the index 3) using Equation 3 and the interleaving rule of the short-length interleaver. In other words:

i=M×sⱼₖ+π(j)=9×0+3=3.

At the same time, the third processor also reads a 4^{th} information block of the 1^{st} sub-block 110 (i.e., a bit corresponding to the index 12) using Equation 3 and the interleaving rule of the short-length interleaver. In other words:

i=M×sⱼₖ+π(j)=9×1+3=12.

Next, at a 2^{nd} point of time, the first processor reads a 6^{th} information block of the 1^{st} sub-block 110 (i.e., a bit corresponding to the index 14) using Equation 3 and the interleaving rule of the short-length interleaver. In other words, i=M×sⱼₖ+π(j)=9×1+5=14.

At the same time, the second processor reads a 6^{th} information block of the 2^{nd} sub-block 120 (i.e., a bit corresponding to the index 23) using Equation 3 and the interleaving rule of the short-length interleaver. In other words:

i=M×sⱼₖ+π(j)=9×2+5=23.

At the same time, the third processor also reads a 6^{th} information block of the 0^{th} sub-block 100 (i.e., a bit corresponding to the index 5) using Equation 3 and the interleaving rule of the short-length interleaver. In other words:

i=M×sⱼₖ+π(j)=9×0+5=5.

Those read index values are interleaved in the second position of each sub-block.

In this way, interleaving is performed on the remaining rows of the matrix S using the interleaving rule of the short-length interleaver. The final interleaving result is (7, 21, 14, 0, 22, 10, 8, 20, 15, 16, 3, 23, 9, 4, 19, 17, 2, 24, 25, 12, 5, 18, 13, 1, 26, 11, 6).

Thus, information blocks included in the same sub-block are likely to be interleaved in different sub-blocks using the interleaving rule of the short-length interleaver, thereby preventing performance degradation. For example, the information block 7 included in the 0th sub-block 100 before interleaving is still included in the 0th sub-block after interleaving, but the information block 6 included in the 0th sub-block 100 before interleaving is included in the 2nd sub-block 120 after interleaving.

When the matrix S is in a Latin square form as illustrated in FIG. 1B, bits read from the same sub-block can be distributed as uniformly as possible after interleaving. The Latin square means a magic square in which values of n types are arranged in an n×n matrix, the number of values of each type is n, and the same value is not arranged in the same row and the same column. Rows of the matrix S can be determined in various ways. First, each row may be generated in a random permutation form. Second, the rows of the matrix S may be generated in the form of repetitions of a Latin square as illustrated in FIG. 1B. Third, by combining those two ways, each row may be generated in the random permutation form while maintaining the Latin square form by being compared with previously generated rows whose number is less than (L−1). Generation of the matrix S using the third way will be described with reference to FIG. 2.

FIG. 2 is a flowchart illustrating a process of generating the matrix S according to an exemplary embodiment of the present invention.

Referring to FIG. 2, in step 201, the first row of the matrix S is initialized to (0, 1, . . . , L−1). L indicates the number of sub-blocks as previously described with reference to FIG. 1.

In step 203, a count value is initialized to 0. In step 205, a row of the matrix S is generated in a random permutation form. In step 207, it is determined whether the generated row satisfies a Latin square condition when compared to previously generated rows. If so, the process goes to step 209. If not, the process goes to step 205.

In step 209, the generated row is stored as a row corresponding to the count value in the matrix S. In step 211, the count value is incremented by 1. If the count value is less than M in step 213, the process goes back to step 205. If the count value is greater than M in step 213, generation of the matrix S is terminated.

As is apparent from the foregoing description, the present invention can implement a long-length interleaver using a short-length interleaver. In other words, it is possible to implement the long-length interleaver capable of parallel processing using the conventionally used short-length interleaver.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A parallel interleaving method comprising:
(a) dividing K information blocks into L sub-blocks;
(b) selecting a sub-block to be interleaved using a matrix for sub-block selection and selecting an information block from the selected sub-block using a first interleaving rule;
(c) interleaving the selected information block; and
(d) excluding the interleaved information block from the selected sub-block and then repeating (b) and (c).

2. The parallel interleaving method of claim 1, wherein the matrix is composed of repetitions of a matrix that satisfies a Latin square condition.

3. The parallel interleaving method of claim 2, wherein the matrix is composed of L rows and M columns, L indicates the number of sub-blocks, M indicates the number of information blocks for each of the sub-blocks, and M×L is equal to K.

4. The parallel interleaving method of claim 2, wherein the matrix is composed of M rows and L columns, M indicates the number of sub-blocks, L indicates the number of information blocks for each of the sub-blocks, and M×L is equal to K.

5. The parallel interleaving method of claim 1, wherein (b) uses the following Equation:
i=M×sⱼₖ+π(j)
where M indicates the number of information blocks for each of the sub-blocks, sⱼₖ indicates an element at an intersection of a row and a column of the matrix, and n(j) indicates an j^{th} value according to the first interleaving rule having a length of M.

6. A parallel interleaving apparatus comprising:
L interleavers for dividing K information blocks into L sub-blocks, selecting a sub-block to be interleaved using a matrix for sub-block selection, selecting an information block from the selected sub-block using a first interleaving rule, and interleaving the selected information block; and
a memory for storing the matrix and the first interleaving rule.

7. The parallel interleaving apparatus of claim 6, wherein each of the L interleavers excludes the interleaved information block from the selected sub-block, selects a new information block using the matrix and the first interleaving rule, and repeats interleaving for the selected information block.

8. The parallel interleaving apparatus of claim 6, wherein the matrix satisfies a Latin square condition.

9. The parallel interleaving apparatus of claim 8, wherein the matrix is composed of L rows and M columns, L indicates the number of sub-blocks, M indicates the number of information blocks for each of the sub-blocks, and M×L is equal to K.

10. The parallel interleaving apparatus of claim 8, wherein the matrix is composed of M rows and L columns, M indicates the number of sub-blocks, L indicates the number of information blocks for each of the sub-blocks, and M×L is equal to K.

11. The parallel interleaving apparatus of claim 6, wherein each of the L interleavers interleaves the selected information block using the following Equation:
i=M×sⱼₖ+π(j)
where M indicates the number of information blocks for each of the sub-blocks, sⱼₖ indicates an element at an intersection of a row and a column of the matrix, and n(j) indicates an j^{th} value according to the first interleaving rule having a length of M.

12. A packet service communication system operable to transmit burst packet data to a plurality of mobile stations, the packet service communication system including a parallel interleaving apparatus comprising:
L interleavers for dividing K information blocks into L sub-blocks, selecting a sub-block to be interleaved using a matrix for sub-block selection, selecting an information block from the selected sub-block using a first interleaving rule, and interleaving the selected information block; and
a memory for storing the matrix and the first interleaving rule.

13. The packet service communication system of claim 12, wherein each of the L interleavers excludes the interleaved information block from the selected sub-block, selects a new information block using the matrix and the first interleaving rule, and repeats interleaving for the selected information block.

14. The packet service communication system of claim 12, wherein the matrix satisfies a Latin square condition.

15. The packet service communication system of claim 14, wherein the matrix is composed of L rows and M columns, L indicates the number of sub-blocks, M indicates the number of information blocks for each of the sub-blocks, and M×L is equal to K.

16. The packet service communication system of claim 14, wherein the matrix is composed of M rows and L columns, M indicates the number of sub-blocks, L indicates the number of information blocks for each of the sub-blocks, and M×L is equal to K.

17. The packet service communication system of claim 12, wherein each of the L interleavers interleaves the selected information block using the following Equation:
i=M×sⱼₖ+π(j)
where M indicates the number of information blocks for each of the sub-blocks, sⱼₖ indicates an element at an intersection of a row and a column of the matrix, and n(j) indicates an j^{th} value according to the first interleaving rule having a length of M.

18. A parallel interleaving method comprising:
generating K information blocks to be transmitted;
dividing the generated K information blocks into L sub-blocks such that each of the L sub-blocks comprises M information blocks; and
selecting an information block from each of the L sub-blocks and interleaving the selected information block,
wherein the M information blocks in each of the L sub-blocks are located at random, and the selection and interleaving of the information block comprises selecting and interleaving the information block determined by multiplying the M information blocks by the number of L sub-blocks and adding indices of the M information blocks located at random in each of the L sub-blocks to multiplication results.

19. The parallel interleaving method of claim 18, wherein positions of the information blocks are the same across the L sub-blocks.

20. The parallel interleaving method of claim 18, wherein the indices of the M information blocks are expressed by M integers.

21. The parallel interleaving method of claim 18, wherein results acquired by multiplying the M information blocks by the number of L sub-blocks and adding the indices of the M information blocks located at random in each of the L sub-blocks to the multiplication results are not greater than K.

22. A parallel interleaving apparatus comprising:
an interleaver for dividing K transmission information blocks into L sub-blocks such that each of the L sub-blocks comprises M information blocks, selecting an information block from each of the L sub-blocks, and interleaving the selected information block,
wherein the M information blocks in each of the L sub-blocks are located at random, and the interleaver selects and interleaves the information block determined by multiplying the M information blocks by the number of L sub-blocks and adding indices of the M information blocks located at random in each of the L sub-blocks to multiplication results.

23. The parallel interleaving apparatus of claim 22, wherein positions of the M information blocks are the same across the L sub-blocks.

24. The parallel interleaving apparatus of claim 22, wherein the indices of the M information blocks are expressed by M integers.

25. The parallel interleaving apparatus of claim 22, wherein results acquired by multiplying the M information blocks by the number of L sub-blocks and adding the indices of the M information blocks located at random in each of the L sub-blocks to the multiplication results are not greater than K.
